(19) United States
(12) Patent Application Publication
(10) Pub. No.: US 2014/0111741 A1
(43) Pub. Date: Apr. 24, 2014

(54) LIQUID CRYSTAL DISPLAY DEVICE

(71) Applicant: LG DISPLAY CO., LTD., Seoul (KR)

(72) Inventors: YoungBae Han, Gumi-si (KR); JaHyun Kim, Yangsan-si (KR)

(73) Assignee: LG DISPLAY CO., LTD., Seoul (KR)

(21) Appl. No.: 14/061,496

(22) Filed: Oct. 23, 2013

(30) Foreign Application Priority Data
Oct. 24, 2012 (KR) 10-2012-0118614

(51) Int. Cl. G02F 1/1335

(52) U.S. Cl. CPC G02F 1/133524
USPC 349/62

(57) ABSTRACT

A liquid crystal display device includes: a liquid crystal panel outputting an image; a light guide plate installed below the liquid crystal panel to transfer light from a backlight unit to the liquid crystal panel; a plurality of optical sheets installed between the liquid crystal panel and the light guide plate; a reflective plate installed below the light guide plate; and a viewing angle control sheet installed between the liquid crystal panel and the optical sheet and having a diffractive pattern formed on an upper surface of a base film and a prism pattern formed on a lower surface of the base film to control a viewing angle. In the LCD device having a viewing angle controllable backlight unit, a viewing angle control sheet capable of freely controlling light output is manufactured by forming a diffractive pattern on an upper surface thereof and a prism pattern on a lower surface thereof, and an application of the viewing angle control sheet to a vehicle backlight unit provides viewing angle characteristics allow for optimum driving conditions.

### CROSS-REFERENCE TO RELATED APPLICATION

Pursuant to 35 U.S.C. §119(a), this application claims the benefit of earlier filing date and right of priority to Korean Application No. 10-2012-0118614, filed on Oct. 24, 2012, the contents of which is incorporated by reference herein in its entirety.

### BACKGROUND

1. Field of the Disclosure

The present disclosure relates to a liquid crystal display device, and particularly, to a liquid crystal display device having a viewing angle controllable backlight unit (or a backlight unit able to control a viewing angle).

2. Background

In general, a liquid crystal display (LCD) device is a display device displaying a desired image by adjusting light transmittance of pixels arranged in a matrix form therein by individually supplying data signals according to image information to the pixels.

Thus, an LCD device includes the pixels and a driving unit for driving the liquid crystal panel in which pixels are arranged in a matrix.

The liquid crystal panel includes a color filter substrate and an array substrate attached in a facing manner with a uniform cell gap maintained therebetween, and a liquid crystal layer formed in the cell gap between the color filter substrate and the array substrate.

Here, a common electrode and pixel electrodes are formed on the liquid crystal panel formed by attaching the color filter substrate and the array substrate to apply an electric field to the liquid crystal layer.

Thus, in a state in which a voltage is applied to the common electrode, when a voltage of a data signal applied to the pixel electrode is controlled, liquid crystals of the liquid crystal layer are rotated according to dielectric anisotropy according to an electric field between the common electrode and the pixel electrode, whereby light is transmitted or blocked by pixels to display characters or an image.

Here, the LCD device is a light-receiving device which displays an image by regulating transmittance of light coming from the outside, rather than being self-luminous, so it requires a device for irradiating light to the liquid crystal panel, i.e., a backlight unit.

Hereinafter, a general LCD device will be described in detail with reference to the accompanying drawings.

FIG. 1 is an exploded perspective view schematically illustrating a structure of a general LCD device.

As illustrated, a general LCD device includes a liquid crystal panel 10 in which pixels are arranged in a matrix to output an image, driving units 15 and 16 for driving the pixels, a backlight unit installed on a rear surface of the liquid crystal panel 10 to emit light to the liquid crystal panel, and a panel guide 45 fixedly accommodating the liquid crystal panel 10 and the backlight unit.

Here, although not shown in detail, the liquid crystal panel 10 includes a color filter substrate and an array substrate attached in a facing manner such that a uniform cell gap is maintained therebetween, and a liquid crystal layer formed in the cell gap between the color filter substrate and the array substrate.

A common electrode and pixel electrodes are formed on the liquid crystal panel formed by attaching the color filter substrate and the array substrate to apply an electric field to the liquid crystal layer. In a state in which a voltage is applied to the common electrode, when a voltage of a data signal applied to the pixel electrode is controlled, liquid crystal of the liquid crystal layer is rotated by dielectric anisotropy according to an electric field between the common electrode and the pixel electrode, whereby light is transmitted or blocked by pixels to display characters or an image.

In order to control a voltage of a data signal applied to the pixel electrode by pixels, a switching element such as a thin film transistor (TFT) is provided in the pixels.

Upper and lower polarizers (not shown) are attached to an outer side of the liquid crystal panel 10 configured as described above. The lower polarizer polarizes light that has passed through the backlight unit, and the upper polarizer polarizes light that has passed through the liquid crystal panel 10.

A backlight unit used as a light source of the liquid crystal panel 10 is divided into an edge type backlight unit and a direct type backlight unit according to the way in which a light emitting lamp is disposed.

In case of the edge type backlight unit, lamps (not shown) as a light source are disposed at one side of the liquid crystal panel 10 to supply light. In detail, a plurality of lamps are installed at one side of a light guide plate 42 and a reflective plate 41 is installed on a rear surface of the light guide plate 42.

Light emitted from the lamps is made incident to the side of the light guide plate 42 made of a transparent material, and the reflective plate 41 disposed on a rear surface of the light guide plate 42 reflects light transmitted to the rear surface of the light guide plate 42 toward optical sheets 43 on an upper surface of the light guide plate 42 to thus reduce loss of light and enhance uniformity.

The liquid crystal panel 10 including the color filter substrate and the array substrate is installed through a panel guide 45 in an upper side of the backlight unit configured as described above. The liquid crystal panel 10, the panel guide 45, and the backlight unit are coupled by a lower cover bottom 50 and an upper case top 60 through screws to form an LCD device.

Here, a viewing angle control sheet 44 is provided in an upper portion of the optical sheet 43 to control a viewing angle. The viewing angle control sheet 44 will be described in detail with reference to the accompanying drawings.

FIG. 2 is a perspective view illustrating a structure of a general viewing angle control sheet of FIG. 1.

Also, FIGS. 3A and 3B are views illustrating light output characteristics of a viewing angle control sheet employing a louver.

Referring to FIG. 2, a general viewing angle control sheet 44 includes two sheets of base film 44a made of polycarbonate (PC) and a louver pattern 44b made of black carbon and interposed between the base films 44a to block light made incident in a tilt direction to reduce a up/down viewing angle.

Namely, referring to FIGS. 3A and 3B, the existing viewing angle control sheet 44 allows light perpendicular to the louver pattern 44b to be transmitted therethrough and blocks light made incident in a tilt direction to thus adjust viewing angle in the direction perpendicular to the direction in which the louver pattern 44b is formed.

Due to such characteristics, a screen of the liquid crystal panel 10 is prevented from being reflected in a front glass of a vehicle, helping safety driving.

However, the existing viewing angle control sheet 44 should necessarily have the louver pattern 44b to control a viewing angle, so the upper and lower two sheets of base film 44a are formed to support the louver pattern 44b, increasing costs and forming a slant line spot visible along the louver pattern 44b. Namely, in order to form the louver pattern 44b, the bas films 44a are laminated on upper and lower surfaces of the louver pattern 44b, and in this process, uneven roller pressure causes a line squashed phenomenon, and damage to a portion of the louver causes appearance of a black line or white line defect.

Also, since the louver pattern 44b made of black carbon serves as a light blocking film, it has only an effect of reducing a viewing angle.

Also, since the louver pattern 44b only serves to block incident light, its application is limited.

### SUMMARY

A liquid crystal display device includes: a liquid crystal panel outputting an image; a light guide plate installed below the liquid crystal panel to transfer light from a backlight unit to the liquid crystal panel; a plurality of optical sheets installed between the liquid crystal panel and the light guide plate; a reflective plate installed below the light guide plate; and a viewing angle control sheet installed between the liquid crystal panel and the optical sheet and having a diffractive pattern formed on an upper surface of a base film and a prism pattern formed on a lower surface of the base film to control a viewing angle.

According to embodiments of the present invention, in the LCD device having a viewing angle controllable backlight unit, a viewing angle control sheet capable of freely controlling light output is manufactured by forming a diffractive pattern on an upper surface thereof and a prism pattern on a lower surface thereof, and an application of the viewing angle control sheet to a vehicle backlight unit provides viewing angle characteristics that allow for optimum driving conditions.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is an exploded perspective view schematically illustrating a structure of a general LCD device.

FIG. 2 is a perspective view illustrating a structure of a general viewing angle control sheet of FIG. 1.

FIGS. 3A and 3B are views illustrating light output characteristics of a viewing angle control sheet employing a louver.

FIG. 4 is a cross-sectional view schematically illustrating a partial structure of an LCD device and paths of output light according to a first embodiment of the present invention.

FIGS. 5A and 5B are perspective views schematically illustrating a structure of a viewing angle control sheet of the LCD device according to the first embodiment of the present invention illustrated in FIG. 4.

FIG. 5C is a view illustrating light output characteristics of an asymmetrical triangular prism of a prism pattern in the viewing angle control sheet according to the first embodiment of the present invention.

FIG. 6 is a photograph showing an example of the light output characteristics of the LCD device according to the first embodiment of the present invention.

FIG. 7 is a view illustrating an optimum ratio of an asymmetrical triangular prism of an asymmetrical prism pattern according to the first embodiment of the present invention.

FIGS. 8A and 8B are views schematically illustrating the interior of a vehicle in which front glass reflection is made and the interior of a vehicle in which front glass reflection is improved.

FIG. 9 is a view illustrating a state in which luminance characteristics in both sides of a driver's seat and a passenger seat are optimized.

FIG. 10 is a perspective view schematically illustrating a structure of a viewing angle control sheet according to a second embodiment of the present invention.

FIG. 11 is a photograph showing an example of output characteristics of an LCD device according to the second embodiment of the present invention.

FIG. 12 is a graph showing luminance characteristics over a viewing angle.

FIG. 13 is a view schematically illustrating one symmetrical triangular prism of a symmetrical prim pattern in a viewing angle control sheet according to the second embodiment of the present invention.

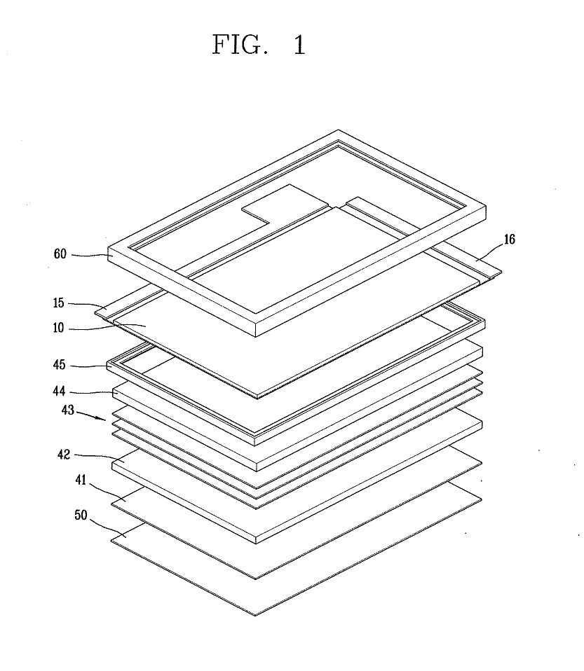

### DETAILED DESCRIPTION OF THE EXEMPLARY EMBODIMENTS

A liquid crystal display (LCD) device having a viewing angle controllable backlight unit according to an embodiment of the present invention will be described with reference to the accompanying drawings such that a person skilled in the art to which the present invention pertains can easily implement it. The present invention may be implemented in various forms and is not limited to the embodiments described herein.

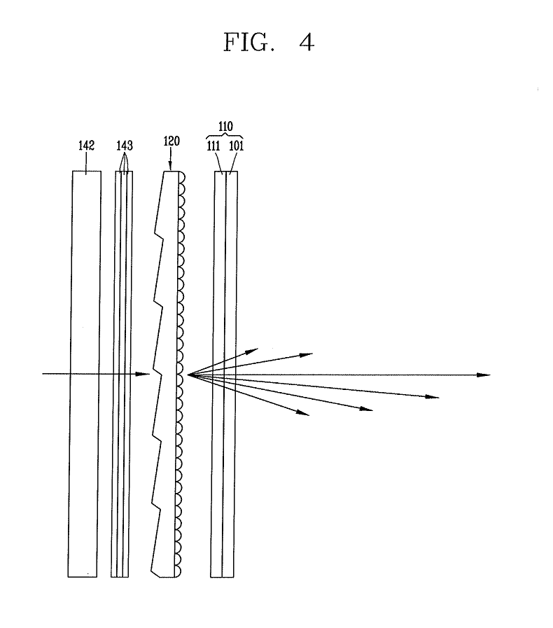

FIG. 4 is a cross-sectional view schematically illustrating a partial structure of an LCD device and paths of output light according to a first embodiment of the present invention.

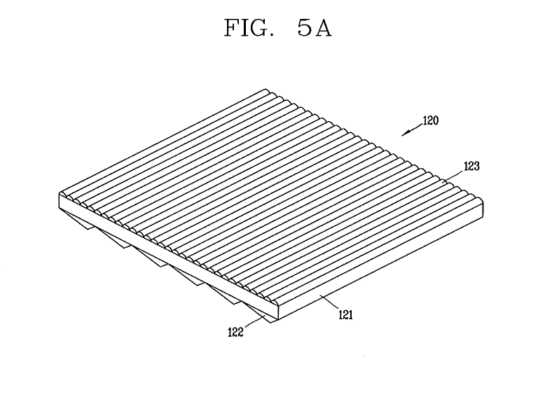

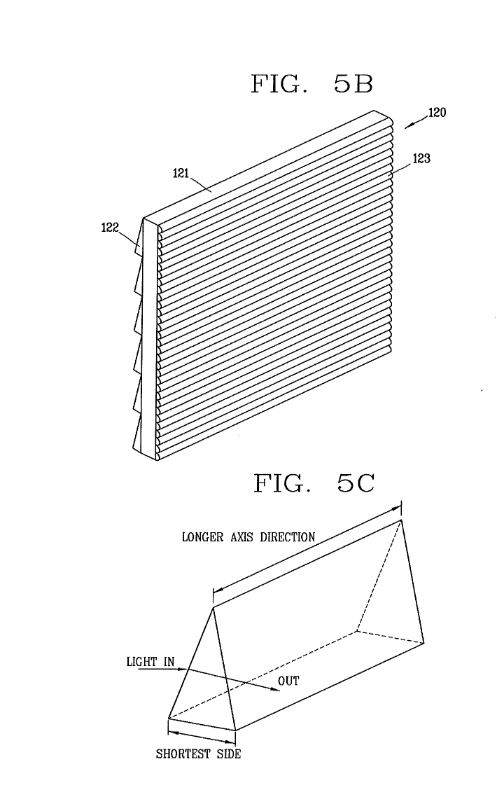

FIGS. 5A and 5B are perspective views schematically illustrating a structure of a viewing angle control sheet of the LCD device according to the first embodiment of the present invention illustrated in FIG. 4. Here, FIG. 5B is a perspective view schematically illustrating a viewing angle control sheet according to the first embodiment of the present invention in consideration of a direction in which an LCD device is disposed in a vehicle in actuality.

FIG. 5C is a view illustrating output characteristics of an asymmetrical triangular prism of a prism pattern in the viewing angle control sheet according to the first embodiment of the present invention.

Referring to the drawings, an LCD device according to the first embodiment of the present invention includes a liquid crystal panel 110 having a rectangular shape and including pixels arranged in a matrix form and outputting an image, a driving unit (not shown) for driving the pixels, a backlight unit BL (not shown) installed on a rear surface of the liquid crystal panel 110 to emit light to the liquid crystal panel 110, and a panel guide (not shown) fixedly accommodating the liquid crystal panel 110 and the backlight unit BL.

Here, the liquid crystal panel 110 includes a color filter substrate 101 and an array substrate 111 attached in a facing manner with a uniform cell gap maintained therebetween, and a liquid crystal layer (not shown) formed in the cell gap between the color filter substrate and the array substrate.

Although not shown, the color filter substrate 101 includes color filters including a plurality of sub-color filters implementing red, green, and blue colors, black matrices demarcating the sub-color filters and blocking light transmitted through the liquid crystal layer, and a transparent common electrode applying a voltage to the liquid crystal layer.

The array substrate 111 includes a plurality of gate lines and data lines arranged vertically and horizontally to define a plurality of pixel regions, thin film transistors (TFTs) as switching elements formed in crossings of the gate lines and the data lines, and pixel electrodes formed in the pixel regions. Here, in case of an in-plane switching (IPS) mode LCD device, a common electrode is formed on the array substrate 111, rather than on the color filter substrate 101.

A common electrode and pixel electrodes are formed on the liquid crystal panel 110 formed by attaching the color filter substrate 101 and the array substrate 111 to apply an electric field to the liquid crystal layer. In a state in which a voltage is applied to the common electrode, when a voltage of a data signal applied to the pixel electrode is controlled, liquid crystal of the liquid crystal layer is rotated by dielectric anisotropy according to an electric field between the common electrode and the pixel electrode, whereby light is transmitted or blocked by pixels to display characters or an image.

In order to control a voltage of a data signal applied to the pixel electrode by pixels, a switching element such as a thin film transistor (TFT) is provided in the pixels.

Upper and lower polarizers (not shown) are attached to an outer side of the liquid crystal panel 110 configured as described above. The lower polarizer polarizes light that has passed through the backlight unit BL, and the upper polarizer polarizes light that has passed through the liquid crystal panel 110.

The present invention is not limited to a direct scheme or an edge scheme of disposing light emitting lamps. For example, an edge type backlight unit BL will be described in detail. A plurality of lamps (not shown) are installed in one side of a light guide plate 142, and a reflective plate (not shown) is installed on a rear surface of the light guide plate 142.

Here, as the lamps, various light sources such as a cold cathode fluorescent lamp (CCFL), an external electrode fluorescent lamp (EEFL), a hot cathode fluorescent lamp (HCFL), a light emitting diode (LED), and the like, may be used.

Light emitted from the lamps is made incident to the side of the light guide plate 142 made of a transparent material, and the reflective plate disposed on the rear surface of the light guide plate 142 reflects light transmitted to the rear surface of the light guide plate 142 toward optical sheets 143 disposed on an upper surface of the light guide plate 142, thus reducing loss of light and enhancing uniformity.

Here, the optical sheets 143 according to the first embodiment of the present invention includes a diffusion sheet and a prism sheet, and may further include a protective sheet.

The liquid crystal panel 110 including the color filter substrate 101 and the array substrate 111 as described above are installed through a panel guide in an upper portion of the backlight unit BL. Although not shown, the liquid crystal panel 110, the panel guide, and the backlight unit BL are coupled to a lower cover bottom and an upper case top through a plurality of fastening units, to form an LCD device.

Here, a viewing angle control sheet 120 for controlling viewing angle characteristics is provided at an upper side of the optical sheets 143, and in particular, in the viewing angle control sheet 120 according to the first embodiment of the present invention, a diffractive pattern 123 is formed on an upper surface of the base film 121 and a prism pattern 122 is formed on a lower surface of the base film 121, whereby output light can be freely controlled, providing viewing angle characteristics (i.e., the direction of output light, in other words, the luminance characteristics over a viewing angle) toward optimum driving conditions.

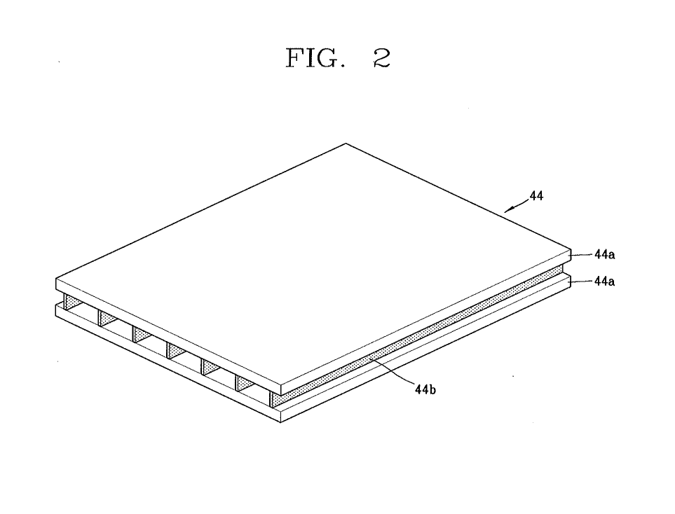

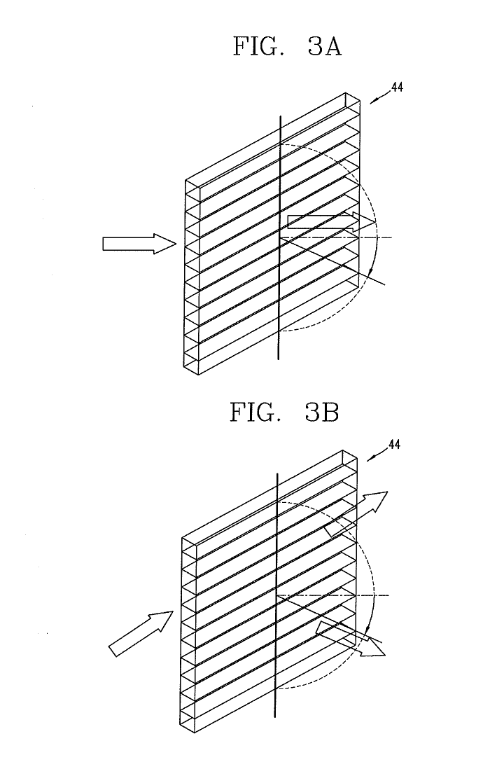

Here, the prism pattern 122 and the diffractive pattern 123 according to the first embodiment of the present invention have a pattern angle of −13˜13° with respect to a horizontal direction of the liquid crystal panel 110 illustrated in FIG. 4. Here, for example, the pattern angle refers to an angle between a horizontal direction of the liquid crystal panel 110 and a longer-axis direction of an asymmetrical triangular prism of the prism pattern and the diffractive pattern when a long side or short side of the liquid crystal panel 110 is disposed in a horizontal direction (see FIG. 2B). In other words, the longer-axis directions of asymmetrical triangular prisms of the prism pattern 122 and the diffractive pattern 123 are parallel to the horizontal direction of the liquid crystal panel 110.

Here, the prism pattern 122 and the diffractive pattern 123 according to the first embodiment of the present invention may have the pattern angle of 0° with respect to the horizontal direction of the liquid crystal panel 110. However, considering of a moire phenomenon, the prism pattern 122 and the diffractive pattern 123 according to the first embodiment of the present invention have the pattern angle of −13˜13° with respect to a horizontal direction of the liquid crystal panel 110.

In particular, the viewing angle control sheet 120 according to the first embodiment of the present invention illustrated in the drawings employs the asymmetrical prism pattern 122 formed on a lower surface of the base film 121 to control a up/down viewing angle.

Namely, as described above, in the related art, in order to solve a front glass reflection phenomenon of a vehicle navigation, a viewing angle control sheet having a louver is applied, but it is costly due to difficulty in a manufacturing process, a degradation of a production yield, and the like, and in addition, a defective outer appearance, such as a generation of a slant line spot, and the like, is continuously generated.

In order to solve the problem, the viewing angle control sheet 120 according to the first embodiment of the present invention includes the diffractive pattern 123 having enhanced diffraction characteristics formed on an upper surface of the base film 121 and the prism pattern 122 having enhanced refraction characteristics formed on a lower surface of the base film 121 to control output light. Thus, desired viewing angle characteristics can be implemented even without a louver.

In this embodiment, the asymmetrical prism pattern 122 formed on the lower surface of the base film 121 (i.e. the side of the light guide plate) shifts a light output direction to the center and a lower side of a screen, preventing a phenomenon that the LCD is reflected in a vehicle front glass (please see FIG. 4), and the diffractive pattern 123 formed on the upper surface of the base film 121 (i.e., the side of the liquid crystal panel) reinforces diffusion of refracted light and a degree of light concentration, improving display quality.

Here, the base film 121 may be made of polycarbonate (PC) or polyethylene terephthalate (PET), and the underlying asymmetrical prism pattern 122 refracts light from a light source in a desired direction, and thus, a shape or angle of the pattern may be adjusted as a designer wants in order to control a viewing angle.

Referring to FIG. 5C, the prism pattern 122 consists of a plurality of the asymmetrical triangular prisms. The triangular prism has a longer axis direction. In this case, in order to shift the light output direction to the center and the lower side of the screen, the shortest side of the asymmetrical triangular prism of the asymmetrical prism pattern 122 may be designed to be positioned in the lower side of the viewing angle control sheet 120 (please see FIG. 5C).

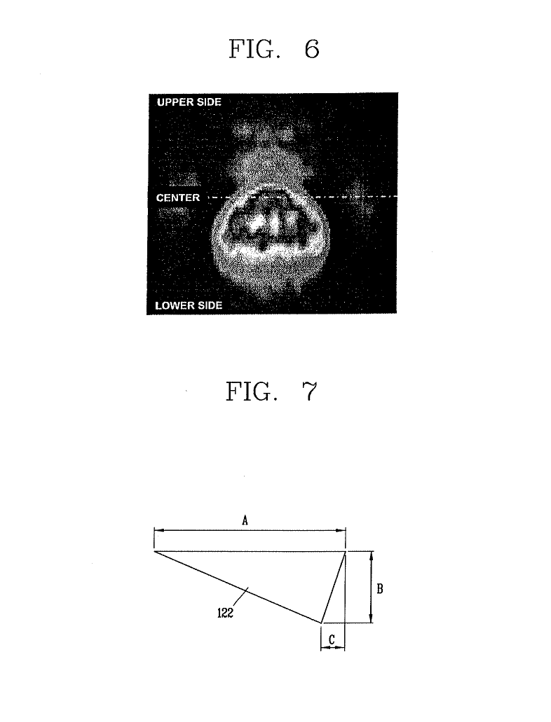

FIG. 6 is a photograph showing an example of the output characteristics (i.e., viewing angle characteristics) of the LCD device according to the first embodiment of the present invention.

Referring to FIG. 6, it can be seen that a light output direction has been shifted to the center and lower side of the screen by the asymmetrical prism pattern.

The asymmetrical triangular prism of the asymmetrical prism pattern 122 according to the first embodiment of the present invention is required to have a predetermined pattern ratio in order to control an up/down viewing angle, as follows.

FIG. 7 is a view illustrating an optimum ratio of an asymmetrical triangular prism of an asymmetrical prism pattern 122 according to the first embodiment of the present invention.

Referring to FIG. 7, in the asymmetrical triangular prism of the asymmetrical prism pattern 122 according to the first embodiment of the present invention, an optimal ratio of a length (A) of the base: a height (B): a length (C) of the shortest side projected to the base is 8:4:1.

Here, the height (B) of the asymmetrical triangular prism of the asymmetrical prism pattern 122 satisfies a condition of A/4≦B≦A/2, and the length (C) of the shortest projected to the base satisfies a condition of B/8≦C≦B/3.

Here, a case in which the hypotenuses (two sides excluding the base) of the asymmetrical prism pattern 122 has a linear shape is illustrated, but the present invention is not limited thereto and the hypotenuses may be convex or concave.

Also, a lattice pitch or height of the diffractive pattern 123 may be adjusted in order to enhance display quality by diffracting and diffusing light that has passed through the asymmetrical prism pattern 122. For example, a lattice pitch may have a value ranging from 1 μm to 10 μm.

Here, the diffractive pattern 123 may have a convex shape with a predetermined curvature, or may have a shape close to a straight line or a concave shape. Also, a height of the diffractive pattern 123 may be designed to be equal to or less than two times the lattice pitch.

A forming process of the diffraction and prism patterns 123 and 122 is relatively simple, enhancing production efficiency, and since only a sheet of base film 121 is used without a louver, manufacturing cost can be reduced, relative to an existing process. In particular, a vehicle front glass reflection phenomenon can be minimized (an upper half power angle equal to or less than 20° can be secured) by adjusting a up/down viewing angle by using the asymmetrical prism pattern 122 as in the first embodiment of the present invention. Here, the half power angle refers to a viewing angle at which luminance is 50% when luminance at the center is 100%.

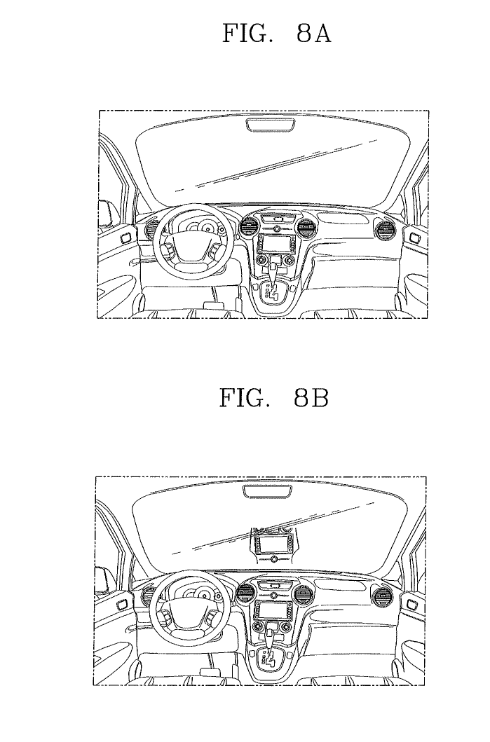

FIGS. 8A and 8B are views schematically illustrating the interior of a vehicle in which front glass reflection is made and the interior of a vehicle in which front glass reflection is improved.

FIG. 8B illustrates the interior of a vehicle in which front glass reflection is improved by applying the viewing angle control sheet according to the first embodiment of the present invention.

Referring to the drawings, when the viewing angle control sheet according to the first embodiment of the present invention is applied, a light output direction is shifted to the center and lower side of the screen, preventing the occurrence of the phenomenon in which a navigation screen is reflected in the front glass of the vehicle.

Meanwhile, in an embodiment of the present invention, an optimal luminance condition of a driver's seat and a passenger seat can be secured by adjusting a left/right viewing angle by using a symmetrical prism pattern, instead of the asymmetrical prism pattern formed on the lower surface of the viewing angle control sheet. This will be described in detail through a second embodiment of the present invention.

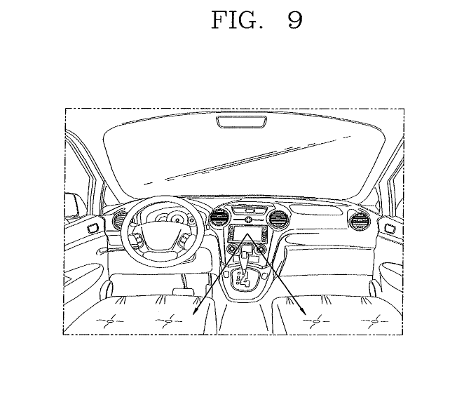

FIG. 9 is a view illustrating a state in which luminance characteristics in both sides of a driver's seat and a passenger seat are optimized.

Referring to FIG. 9, within an actual vehicle, a navigation screen is mainly viewed from a driver's seat or a passenger seat, so a viewing angle control sheet is required to be optically designed to have double peaks in the left/right viewing angle direction, rather than increasing central luminance of the screen.

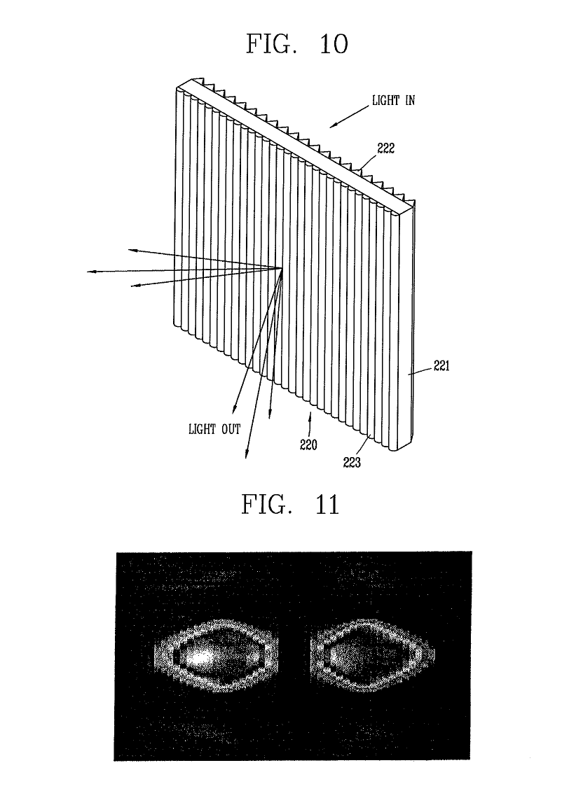

FIG. 10 is a perspective view schematically illustrating a structure of a viewing angle control sheet according to a second embodiment of the present invention.

Here, FIG. 10 is a perspective view of the viewing angle control sheet according to the second embodiment of the present invention in consideration of a direction in which the LCD device is actually disposed in a vehicle.

Like the LCD device according to the first embodiment of the present invention as described above, the LCD device according to the second embodiment of the present invention includes a liquid crystal panel including pixels arranged in a matrix form and outputting an image, a driving unit for driving the pixels, a backlight unit installed on a rear surface of the liquid crystal panel to emit light to the liquid crystal panel, and a panel guide fixedly accommodating the liquid crystal panel and the backlight unit.

Here, the liquid crystal panel includes a color filter substrate and an array substrate attached in a facing manner with a uniform cell gap maintained therebetween, and a liquid crystal layer formed in the cell gap between the color filter substrate and the array substrate.

Upper and lower polarizers are attached to an outer side of the liquid crystal panel configured as described above. The lower polarizer polarizes light that has passed through the backlight unit, and the upper polarizer polarizes light that has passed through the liquid crystal panel.

The edge type backlight unit will be described in detail, for example. In the edge type backlight unit, a plurality of lamps are installed in one side of the light guide plate and a reflector is installed on a rear surface of the light guide plate.

Light emitted from the lamps is made incident to the side of the light guide plate made of a transparent material, and the reflective plate disposed on the rear surface of the light guide plate reflects light transmitted to the rear surface of the light guide plate toward optical sheets disposed on an upper surface of the light guide plate, thus reducing loss of light and enhancing uniformity.

The liquid crystal panel including the color filter substrate and the array substrate as described above are installed through a panel guide in an upper portion of the backlight unit. The liquid crystal panel, the panel guide, and the backlight unit are coupled to a lower cover bottom and an upper case top through a plurality of fastening units, to form an LCD device.

Referring to FIG. 10, in an embodiment of the present invention, a viewing angle control sheet 220 for controlling a viewing angle is provided in an upper side of the optical sheets, and in particular, in the viewing angle control sheet 220 according to the second embodiment of the present invention, a diffractive pattern 223 is formed on an upper surface of the base film 221 (i.e., the side of the liquid crystal panel) and a prism pattern 222 is formed on a lower surface of the base film 221 (i.e., the side of the light guide plate), whereby output light can be freely controlled, providing viewing angle characteristics toward optimum driving conditions.

Here, unlike the first embodiment of the present invention as described above, the symmetrical prism pattern 222 and the diffractive pattern 223 according to the second embodiment of the present invention have a pattern angle of 85˜95° with respect to a horizontal direction of the liquid crystal panel. In other words, the horizontal direction of the liquid crystal panel is perpendicular to the longer-axis directions of symmetrical triangular prisms of the symmetrical prism pattern and the diffractive pattern. The symmetrical prism pattern 222 consists of a plurality of symmetrical triangular prisms.

Here, the prism pattern 222 and the diffractive pattern 223 according to the second embodiment of the present invention may have the pattern angle of 90° with respect to the horizontal direction of the liquid crystal panel. However, considering of the moire phenomenon, the prism pattern 222 and the diffractive pattern 223 according to the second embodiment of the present invention have the pattern angle of 85˜95° with respect to a horizontal direction of the liquid crystal panel.

In particular, the viewing angle control sheet 220 according to the second embodiment of the present invention employs the symmetrical prism pattern 222 formed on a lower surface of the base film 221 to control a left/right viewing angle.

In this manner, the viewing angle control sheet 220 according to the second embodiment of the present invention has the symmetrical prism pattern 222, instead of the asymmetrical prism pattern, a light output direction can be shifted to the left and right sides of the screen, and thus, output light optimized for the driver's seat and the passenger seat can be obtained, and display quality can be enhanced by reinforcing diffusion of refracted light and a degree of light concentration with the diffractive pattern 223 formed on the upper surface of the viewing angle control sheet 220.

FIG. 11 is a photograph showing an example of output characteristics of an LCD device according to the second embodiment of the present invention.

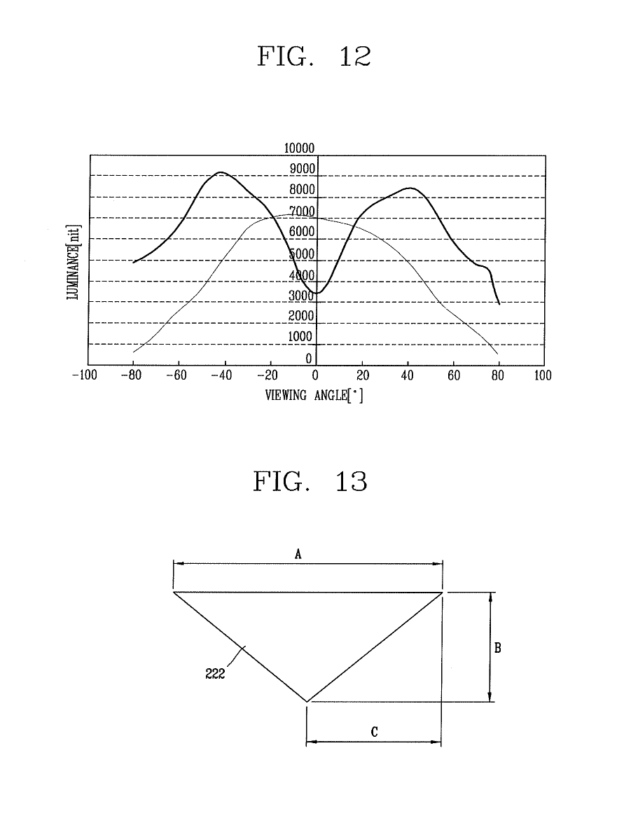

FIG. 12 is a graph showing luminance characteristics over a viewing angle. Here, the graph indicated by the dim line 901 represents luminance characteristics according to a viewing angle when the existing viewing angle control sheet is applied, and the graph indicated by the strong line 902 represents luminance characteristics according to a viewing angle when the viewing angle control sheet according to the second embodiment of the present invention is applied.

Referring to the drawings, double peaks are formed in a left/right viewing angle direction by the symmetrical prism pattern, so it can be seen that the light output direction has been shifted to the left and right sides from the center of the screen.

The symmetrical triangular prism of the symmetrical prism pattern 222 according to the second embodiment of the present invention is required to have a predetermined pattern ratio in order to control an up/down viewing angle, as follows.

FIG. 13 is a view schematically illustrating one symmetrical triangular prism of a symmetrical prim pattern in a viewing angle control sheet according to the second embodiment of the present invention.

Referring to FIG. 13, in the symmetrical triangular prism of the symmetrical prism pattern 222 according to the second embodiment of the present invention, an optimal ratio of a length (A) of the base: a height (B): half (C) of the length of the base is 2:1:1. However, the present invention is not limited thereto and the ratio may be changed according to a design value of a left/right viewing angle.

Here, the height (B) of the symmetrical triangular prism of the symmetrical prism pattern 222 satisfies a condition B≦A.

Here, a case in which the hypotenuses (two sides excluding the base) of the asymmetrical prism pattern 222 has a linear shape is illustrated, but the present invention is not limited thereto and the hypotenuses may be convex or concave.

Also, a lattice pitch or height of the diffractive pattern 223 may be adjusted in order to enhance display quality by diffracting and diffusing light that has passed through the symmetrical prism pattern 222. For example, a lattice pitch may have a value ranging from 1 μm all to 10 μm all.

Here, the hypotenuses of the diffractive pattern 223 may have a convex shape with a predetermined curvature, or may have a shape close to a straight line or a concave shape. Also, a height of the diffractive pattern 223 may be designed to be equal to or less than two times the lattice pitch.

Like the first embodiment of the present invention as described above, a forming process of the diffraction and prism patterns 223 and 222 is relatively simple, enhancing production efficiency, and since only a sheet of base film 221 is used without a louver, manufacturing cost can be reduced, relative to an existing process. In particular, an optimal luminance condition of the driver's seat and the passenger seat can be secured by adjusting a left/right viewing angle (angles of the double peaks can be controlled) by using the symmetrical prism pattern 222 as in the second embodiment of the present invention.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A liquid crystal display device comprising:
a liquid crystal panel outputting an image;
a light guide plate disposed below the liquid crystal panel to transfer light from a backlight unit to the liquid crystal panel; and
a viewing angle control sheet disposed between the liquid crystal panel and the light guide plate and having a diffractive pattern formed on a liquid crystal panel side of a base film and a prism pattern formed on a light guide plate side of the base film to control viewing angle characteristics.

2. The liquid crystal display device of claim 1, wherein the prism pattern comprises a plurality of triangular prisms, the triangular prism having a longer axis, and wherein when the liquid crystal panel is disposed in a horizontal direction, the prism pattern and the diffractive pattern has a pattern angle of −13˜13° (the pattern angle being an angle between a horizontal direction of the liquid crystal panel and the longer axis direction of the triangular prism and the diffractive pattern) with respect to the horizontal direction of the liquid crystal panel.

3. The liquid crystal display device of claim 2, wherein the prism pattern is an asymmetrical prism pattern to shift a light output direction to a front side and a lower side of a screen, the asymmetrical prism pattern consisting of a plurality of asymmetrical triangular prisms.

4. The liquid crystal display device of claim 3, wherein the shortest side of the asymmetrical triangular prism is positioned in a lower portion of the viewing angle control sheet.

5. The liquid crystal display device of claim 4, wherein, in the asymmetrical triangular prism, an optimal ratio of a length (A) of the base attached to the base film: a height (B): a length (C) of the shortest side projected to the base is 8:4:1.

6. The liquid crystal display device of claim 5, wherein the height (B) of the asymmetrical triangular prism satisfies a condition of A/4≦B≦A/2, and the length (C) of the shortest side projected to the base satisfies a condition of B/8≦C≦B/3.

7. The liquid crystal display device of claim 1, wherein when the liquid crystal panel is disposed in a horizontal direction, the prism pattern and the diffractive pattern have a pattern angle of 85˜95° (the pattern angle being an angle between the horizontal direction of the liquid crystal panel and the longer axis direction of the prism pattern and the diffractive pattern) with respect to the horizontal direction of the liquid crystal panel.

8. The liquid crystal display device of claim 7, wherein the prism pattern is a symmetrical prism pattern to shift a light output direction to the left and right sides of the screen, the symmetrical prism pattern consisting of a plurality of symmetrical triangular prisms.

9. The liquid crystal display device of claim 8, wherein, in the symmetrical triangular prism of the symmetrical prism pattern, an optimal ratio of a length (A) of the base attached to the base film: a height (B): half (C) of the length of the base is 2:1:1.

10. The liquid crystal display device of claim 9, wherein the height (B) of the symmetrical triangular prism satisfies a condition of B≦A.

11. The liquid crystal display device of claim 1, wherein a lattice pitch of the diffractive pattern has a value ranging from 1 μm to 10 μm.
